(19) United States
(12) Patent Application Publication
(10) Pub. No.: US 2004/0047466 A1
(43) Pub. Date: Mar. 11, 2004

(54) Advanced encryption standard hardware accelerator and method

(76) Inventors: Joel Feldman, Phoenix, AZ (US); Thomas Tkacik, Phoenix, AZ (US)

Correspondence Address: MOTOROLA INC, AUSTIN INTELLECTUAL PROPERTY, LAW SECTION, 7700 WEST PARMER LANE MD: TX32/PL02, AUSTIN, TX, 78729

(21) Appl. No.: 10/236,806

(22) Filed: Sep. 6, 2002

(51) Int. Cl. H04K 1/04; H04K 1/06

(52) U.S. Cl. 380/37

(57) ABSTRACT

A method of performing encryption and decryption includes implementing a block cipher algorithm, generating encryption and decryption round keys for an accelerator module, and implementing the accelerator module using shared logic for one or more round key sizes, wherein the decryption uses a stored expanded key word to initialize subsequent block decryptions. The block cipher algorithm can be the Rijndael algorithm. Only a first block decryption requires expansion overhead. All subsequent block decryptions utilize a prior key to initialize a key expansion engine for a plurality of subsequent blocks. The subsequent block decryptions are performed at a same rate as block encryptions. An apparatus includes a plurality of logic gates configured to reuse expanded round keys from a prior decryption round, the logic gates complete one round of data decryption per clock cycle after an initial round of data decryption, and a plurality of decoders configured to convert the decrypted data to usable data.

### BACKGROUND OF THE INVENTION

1. Field of the Invention

The present invention is related to the Advanced Encryption Standard, transferring of data securely, and, more particularly to implementing an efficient integrated circuit architecture.

2. Description of the Related Art

The incorporation of orbiting satellites to communications services rendered it no longer possible to dedicate a direct line from sender to receiver. Messages of a sensitive or private nature are released to the airwaves with other public messages and can be intercepted by anyone with a receiver. Therefore, it is important for a sender to encode sensitive messages. To understand the original message, the receiver must decode the message. Both the sender and the receiver require similar apparatus that operate synchronously. The apparatus is preferably portable, affordable, dependable and fast enough to avoid restricting data flow.

In October of 2000, the Rijndael algorithm was selected by the National Institute for Standards & Technology (NIST) as the Advanced Encryption Standard (AES). The new AES was designed to work more efficiently than prior encryption standards. AES is a symmetric key block cipher algorithm, meaning that data is processed in fixed sized blocks wherein the output is the same size as the input. A symmetric shared key is used both for encryption and decryption. The key size is selectable from 128, 192, and 256 bits. The Rijndael algorithm is mathematically based on matrix manipulations and binary polynomial operations in a finite field Galois Field (GF) (2⁸). Each round operates on a state matrix. Inherently, it is a 32-bit algorithm. To support 128-bit blocks, four 32-bit words are processed at a time. Herein, a word refers to a long word of 32 bits.

Current software implementations of the AES algorithm are not efficient for bulk data encryption. High-speed communication applications demand equivalent encryption/decryption performance, however the additional overhead involved in performing the algorithm can degrade system performance. Some embedded processors do not have the available memory to efficiently process the AES algorithm. Decryption performance currently is significantly limited because the key schedule must be fully expanded before decryption can begin. What is needed is a dedicated hardware co-processor that can take advantage of parallelism in encryption rounds, offers higher throughput, and does not use up a host processor's resources. Additionally, what is needed is a system that does not degrade when changing message context by interleaving messages with different keys.

### SUMMARY OF THE INVENTION

A method of performing encryption and decryption includes implementing a block cipher algorithm, generating encryption and decryption round keys for an accelerator module, and implementing the accelerator module using shared logic for one or more round key sizes, wherein the decryption uses a stored expanded key word to initialize subsequent block decryptions. The block cipher algorithm can be Rijndael. Only a first block decryption requires expansion overhead. All subsequent block decryptions utilize a prior key to initialize a key expansion engine for a plurality of subsequent blocks. The subsequent block decryptions are performed at a same rate as block encryptions.

Another method according to an embodiment for decrypting a first message thread and a second message thread includes creating a first key schedule including a first set of one or more key words, reading the first set of one or more sub-key words to an external location, decrypting at least a portion of the first message thread using the first set of one or more sub-key words, creating a second key schedule including a second set of one or more sub-key words, reading the second set of one or more sub-key words to an external location, decrypting at least a portion of the second message thread using the second set of sub-key words, and returning to decrypting the first message thread via restoring the first set of sub-key words from the external location.

An apparatus includes a plurality of logic gates configured to reuse expanded round keys from a prior decryption round, the logic gates complete one round of data decryption per clock cycle after an initial round of data decryption, and a plurality of decoders configured to convert the decrypted data to usable data.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 illustrates a flow diagram of a method in accordance with an embodiment of the present invention.

FIG. 2 illustrates a key schedule block diagram according to an embodiment of the present invention.

FIG. 3 is a block diagram of the encrypt/decrypt apparatus as an overview in accordance with an embodiment of the present invention.

FIG. 4 is block diagram illustrating key expansion in accordance with an embodiment of the present invention.

FIG. 5 illustrates a logic diagram illustrating key expansion for a key size (Nk) of four or six in accordance with an embodiment of the present invention.

FIG. 6 illustrates a logic diagram illustrating reverse key expansion for an Nk of four or six in accordance with an embodiment of the present invention.

FIG. 7 illustrates a logic diagram illustrating key expansion for an Nk of 8 in accordance with an embodiment of the present invention.

FIG. 8 illustrates a logic diagram illustrating reverse key expansion for an Nk of 8 in accordance with an embodiment of the present invention.

FIG. 9 illustrates a logic diagram illustrating logic sharing for forward key expansion for an Nk of 4, 6 and 8 in accordance with an embodiment of the present invention.

FIG. 10 illustrates a logic diagram illustrating logic sharing for reverse key expansion for an Nk of 4, 6 and 8 in accordance with an embodiment of the present invention

FIG. 11 illustrates a block diagram showing an inverse key function in accordance with an embodiment of the present invention.

FIG. 12 illustrates a block diagram for storing of initial decrypt round keys in accordance with an embodiment of the present invention.

FIG. 13 illustrates a flow diagram of a method for context switching in accordance with an embodiment of the present invention.

FIG. 14 illustrates a flow diagram of a method in accordance with an embodiment of the present invention.

FIG. 15 illustrates another flow diagram of a method in accordance with an embodiment of the present invention.

FIG. 16 illustrates a block diagram of a sub-round block in accordance with an embodiment of the present invention.

FIG. 17 illustrates a block diagram of a byte substitution/mix column function in accordance with an embodiment of the present invention.

FIG. 18 illustrates a block diagram of a reverse byte substitution/inverse mix column function in accordance with an embodiment of the present invention.

FIG. 19 illustrates a cipher block chaining block diagram in accordance with an embodiment of the present invention.

FIG. 20 illustrates a block diagram showing byte multiplication with inverse coefficients in accordance with an embodiment of the present invention.

FIG. 21 illustrates a block diagram showing an X-time function in accordance with an embodiment of the present invention.

FIG. 22 illustrates a block diagram showing a critical path in accordance with an embodiment of the present invention.

### DETAILED DESCRIPTION

The Rijndael algorithm assists in communications from the sender securing the message by encryption so that only the intended receiver with a similar apparatus is able to apply the algorithm decoding the message for understanding. Both the sender and the receiver use embodiments described herein to pass the electronic communications signal in blocks through a complex array of logic gates. The sender's message is converted to a seemingly unrecognizable pattern of pulses that the receiver is able to interpret by converting the message back to an original format.

FIG. 1 exemplifies the data transfer steps in accordance with an embodiment. Block 100 represents the sender that has created a message. The message is passed through a device that translates the message into electronic pulses that can pass through data lines, represented in block 110. Embedded within this device is an integrated circuit that manipulates the electronic pulses by applying them to the Rijndael algorithm, block 120.

The electronic pulses representing the encoded data can be transferred in many ways without fear of being interpreted by an unintended party. The electronic pulses are received by another device, represented by block 130. The encoding process is reversed to decode the message using the Rijndael algorithm with an embedded integrated circuit represented by block 140. It should be noted that blocks 110 and 140 are capable of performing the other's responsibilities depending upon the direction of the data. The decoded data is then provided to the receiver interpreted back to the original format.

Many implementations of the Rijndael algorithm are known. As a block cipher algorithm, data is processed in fixed sized blocks. Mathematically, the algorithm is based on basic functions, as is known. Those functions include a sub-byte function (referred to herein as an S-box function); an inverse S-box function (also referred to herein as a reverse byte substitution function), a multiplication function (referred to herein as an X-time function); a byte substitution/mix column function; a reverse byte substitution/inverse mix column function; an inverse key word function; and a key expansion function.

Embodiments presented herein have S-box lookups throughout implementations of the algorithm. A 32-bit (4 byte) substitution function is simply a group of S-box byte lookups.

SubByte={sbox[inword[31:24]], sbox[inword[23:16]], sbox[inword[15:8]]. sbox[inword[7:0]]}

An S-box is constructed by calculating the byte multiplications (using X-time) for all hexadecimal values between 0x00 and 0xFF. The multiplicative inverses are also computed.

Power[0]=1, Log[1]=0, Log[0]=0

Power [1]=3, Log[3]=1

For (i=2; i<256; i++)

Power[i]=Power[i−1]\hat{ }xtime(Power[i−1])

Log[Power[i]]=i

Next, the S-box tables are generated:

Sbox[0]=0x64, InvSbox[0x63]=0

For (i=1; i<256; I++)

y=Power[255−Log[i]]

x=y

for (j=0; j<4; j++)

x=ROTL(x)

y=y\hat{ }x

Sbox[i]=y\hat{ }0x63

InvSbox[y\hat{ }0x63]=i

The multiplication of a byte by polynomial term “x” is defined as:

If (byte & 0x80)

xtime=(byte <<1)\hat{ }0x1B

Else

xtime=byte <<1

Byte multiplication, which is a dot product, is performed using the X-time function to generate higher powers of “x”. To multiply a byte “A(x)” by another byte “B(x)”, B(x) can be expressed as a binary polynomial. For example, if B=“0x09”, B is expressed as 1x³+0x²+0x¹+1x⁰. The x³ term is determined by xtime(xtime(xtime(A))). Which gives A(x)* B(x)=xtime(xtime(xtime(A)))\hat{ }A.

Byte substitution and mix column functions use the coefficients 03, 01, 01, 02 as shown:

ByteSub=Sbox[inbyte]

A=ByteMult(01, ByteSub)

B=ByteMult(02, ByteSub)

C=ByteMult(03, ByteSub)

MixColumn={C, A, A, B}

The inverse mix column function uses the inverse coefficients 0B, 0D, 09, 0E as shown:

RevByteSub=InvSbox[inbyte]

A=ByteMult(0B, RevByteSub)

B=ByteMult(0D, RevByteSub)

C=ByteMult(09, RevByteSub)

D=ByteMult(0E, RevByteSub)

InvMixCol={A, B, C, D}

The inverse key word function performs a matrix multiplication of an expanded key word with the inverse coefficients from the inverse mix column function as follows:

M=0x0e090D0B (inverse mix column coefficients)

For (i=3; i>=0; i−−)

prod1=ByteMult(inword[7:0], m[7:0])

prod2=ByteMult(inword[15:8], m[15:8])

prod3=ByteMult(inword[23:16], m[23:16])

prod4=ByteMult(inword[31:24], m[31:24])

Byte_product[i]=prod1\hat{ }prod2\hat{ }prod3\hat{ }prod4

M=ROTL24(m)

Output={byte_product[3],byte_product[2],byte_product[1], byte_product[0]}

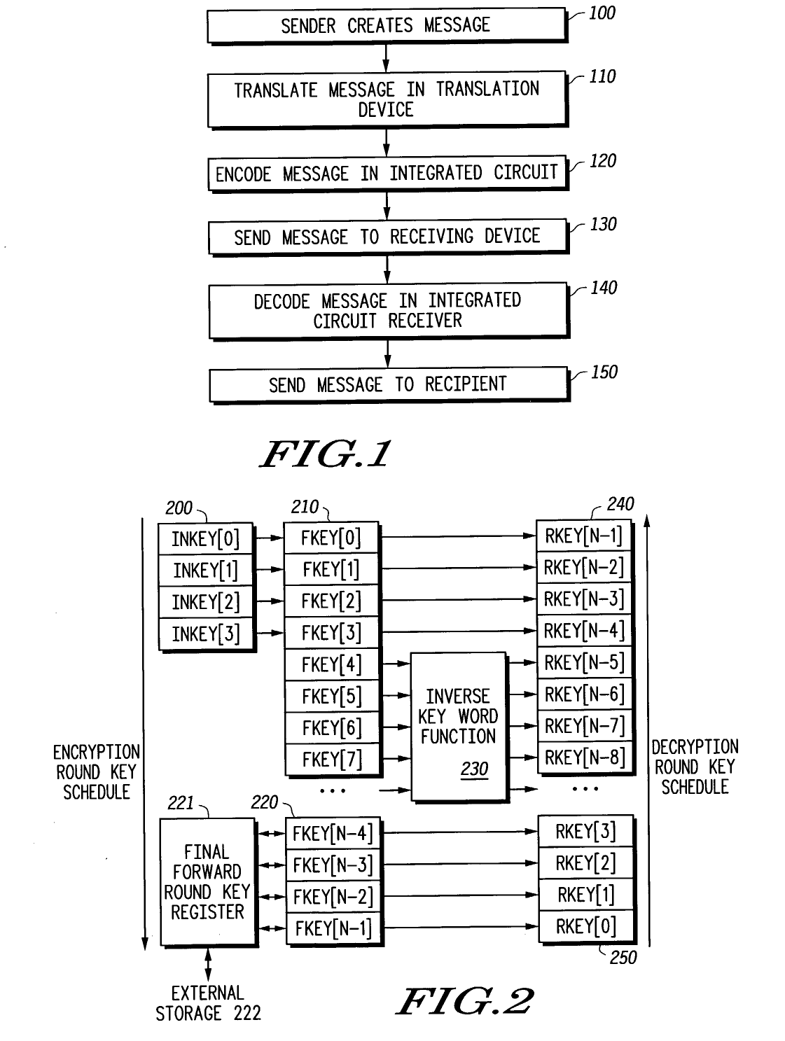

Referring now to FIG. 2, an overview of block processing in accordance with an embodiment is shown. The block processing is performed in two stages. First, a user key is expanded into a key schedule. Each round of encryption then uses a unique set of round keys. Decryption uses the round keys in the reverse order. The key expansion routine is an iterative process. The number of rounds depends on the key size.

Mathematically, the key schedule is calculated as follows:

N=4*rounds
For(I=0;I<key_size;I++)

Key[I]=Inputkey[I]

K=0;
For(j=key_size;j<N;j=j+ke_size,k++)

key[j]=key[j−key_size]\hat{ }SubByte(ROTL24(key[j−1]))\hat{ }round_const[k]
if(key_size<=6)

for(i=1;i<key_size&(i+j)<N;i++)

key[i+j]=key[i+j−key_size]\hat{ }key[i_j=1]

else

for(i=1;i<4&(i_j)<N;i++)

key[i+j]=key[i+j−key_size]\hat{ }key[i+j−1]

if(j+4<N)Key[j+4]=key[j+4−key_size]\hat{ }SubByte(key[j+3])
for(i=5;i<key_size&(i+j)<N;i++)

key[i+j]=key[i+j−key_size]\hat{ }key[i+j−1]

More specifically, block 200 represents the user keys or inputs from the sender. A key expansion engine 200 is initialized with an input key. The input key is stored and expanded into a key schedule as represented in blocks 210 and 220. Final forward round keys are stored in a final forward round key register 221 coupled to block 220. An external storage 222 is coupled to the final forward round key register 221 for external storage of the final forward round keys. The output of the key expansion is reversed for the decryption key schedule shown in blocks 240 and 250. The number of rounds depends on the key size. In one embodiment, the architecture is fixed to 128 bits (4 words). However, one of ordinary skill in the art with the benefit of this disclosure will appreciate that other system requirements may justify a change in the number of registers. For a key size of 192 bits (6 words) an architecture would require 12 rounds. For a key size of 256 bits (8 words) an architecture would require 14 rounds. Each round of encryption combines the working state matrix with a unique set of round keys from blocks 210 and 220. Each round of decryption combines the working state matrix with a unique set of round keys from blocks 250 and 240.

A round constant table is calculated based on the following function:

for(i=0,x=1;i<10

Round_const[i]=x

x=xtime(x)

The inverse key word function represented by block 230 performs a matrix multiplication of an expanded key word with the inverse coefficients from the inverse mix column function. The entire key schedule can be stored in memory and read out in fixed sized blocks. These blocks are then read out in reverse order and subjected to the same matrix multiplication for decryption in block 240 and block 250. As shown in block 230, the inverse key word function is performed on all but the first and last set of round keys used during decryption. Mathematically, the inverse is represented as follows:

for (i=4; i<N−4; i=i+4)

k=N−4−I
for(j=0; j<4; j++)

revkey[k+j]=InvKeyWord(key[i+j])

The encryption rounds use a state matrix. The state matrix is initialized by XORing an input block with the first four round key words (Inkey[127:0]). A sequence of rounds is then performed on the state matrix. Rounds 1 through (N−1) perform functions byte substitution, shift row, mix column and add round keys. The final round (N) does not perform the mix column function.

Four sub-rounds operate on the state during each encryption round. Mathematically, the four sub-rounds function as follows:

For(subround=0;subround<4;subround++)

Keyword[subround]\hat{ }

Mix_col(BYTEstate[subround]\hat{ }

ROTL8(mix_col(BYTEstate[subround+1% 4]>>8))\hat{ }

ROTL16(mix_col(BYTEstate[subround+2% 4]>>16))\hat{ }

ROTL24(mix_col(BYTEstate[subround+3%4 ]>>24))

Decryption rounds begin by the state matrix initializing via XORing the input block with the last four expanded round key words. A similar sequence of rounds is performed on the state matrix as encryption. Rounds 1 through (N−1) perform the following functions: inverse byte substitution; inverse shift row; inverse mix column; add inverse round keys. The final round (N) does not perform the inverse mix column function. Four sub-rounds operate on the state during each decryption round.

Mathematically, the decryption rounds can be represented as follows:

For(subround=0;subround<4; subround++)

Invkeyword[subround]\hat{ }

Invmix_col(BYTE state[subround])\hat{ }

ROTL8(invmix_col(BYTE state[subround+3% 4]>>8))\hat{ }

ROTL16(invmix_col(BYTE state[subround+2% 4]>>16)\hat{ }

ROTL24(invmix_col(BYTE state[subround+1% 4]>>24))

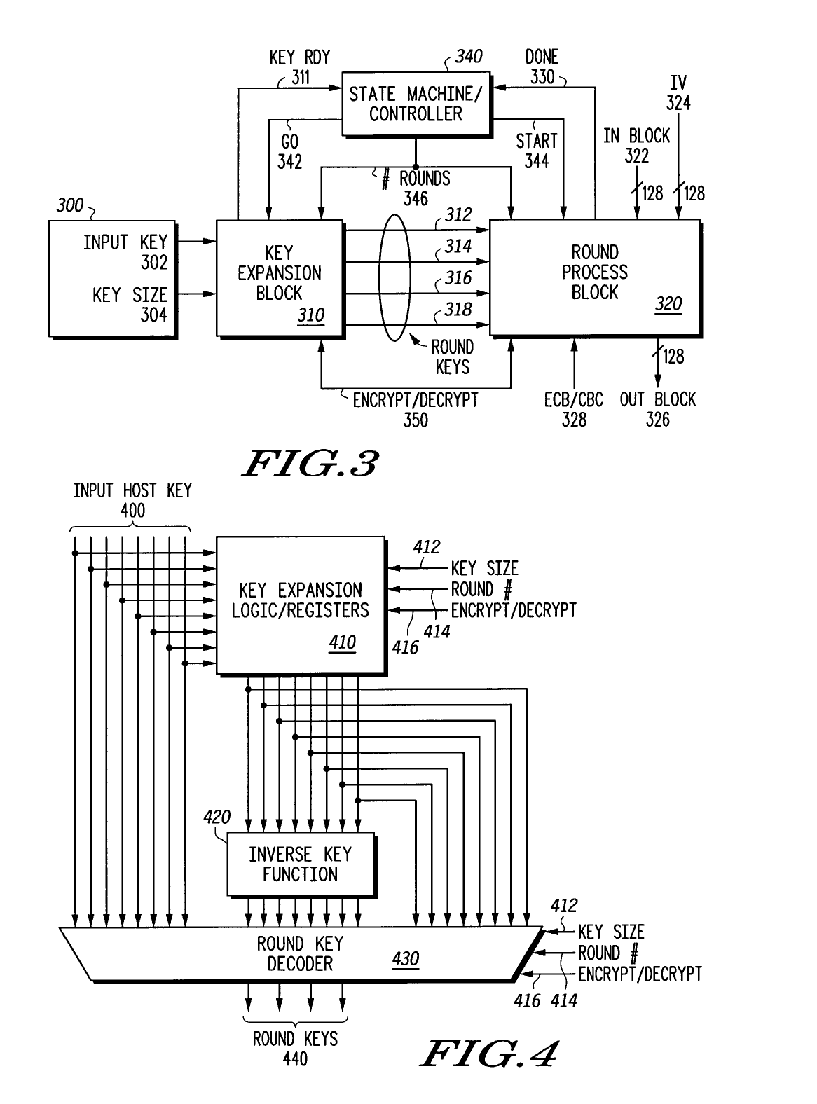

Referring now to FIG. 3, a block diagram of an encryption system appropriate for embodiments herein is shown. More specifically, input block 300 provides for inputs from a device, for example, including input key 302 and key size 304. Input key 302 and key size 304 are received by block 310 for key expansion. This block 310 takes the four inputs and expands the four inputs to four outputs and manipulates the four outputs according to key size input 304. Key expansion block 310 provides round keys 312, 314, 316 and 318 to round process block 320. Because each set of round keys is only used once, the round keys are generated on the fly. The key expansion routine is inherently iterative. While the key size (Nk) is selectable form 4, 6 or 8 words depending on the bit size of the key, each round only uses 4 key words at a time. To generate a new group of Nk round keys, the previous Nk round keys must be stored. For a key size Nk=4, the process is such that each cycle generates 4 round keys that are all consumed in that cycle. For a key size Nk=6, each cycle generates 6 round keys, four of which are consumed in that round. The remaining two round keys are rotated to the next round. A sliding window approach can be used to select the 4 round keys that are consumed in a round. For a key size of Nk=8, every two cycles generates eight round keys. The first four keys are used in odd rounds and the other 4 keys are used in even rounds.

Round process block 320 receives inputs, 322 and 324, which are 128 bit signals, “in Block” and “IV” representing an initialization vector and an input block. Round Process block 320 further receives signal 328 labeled ECB/CBC, which stands for electronic codebook and cipher block chaining. When the mode is set to ECB, each input block is processed independently. In CBC mode, the previous block is used to process the next block. CBC mode requires a 128-bit initialization vector (IV) to start processing the first block. For encryption, the input block is mixed with the IV prior to initializing a state matrix. Round Process block 320 outputs a 128-bit signal 326. Signal 350 is coupled to both key expansion block 310 and round process block 320 to determine whether the system will be set to encrypting or decrypting. The encryption system further includes a state machine/controller 340 which receives a key ready signal 311 from key expansion block 310 and done signal 330 from round process block 320. State machine controller 340 generates a go signal 342 for the key expansion block 310 as well as a start signal 344 for the round process block 320. Further, state machine controller 340 defines the number of rounds to be used by both the key expansion block 310 and the round process block 320 as shown by signal 346.

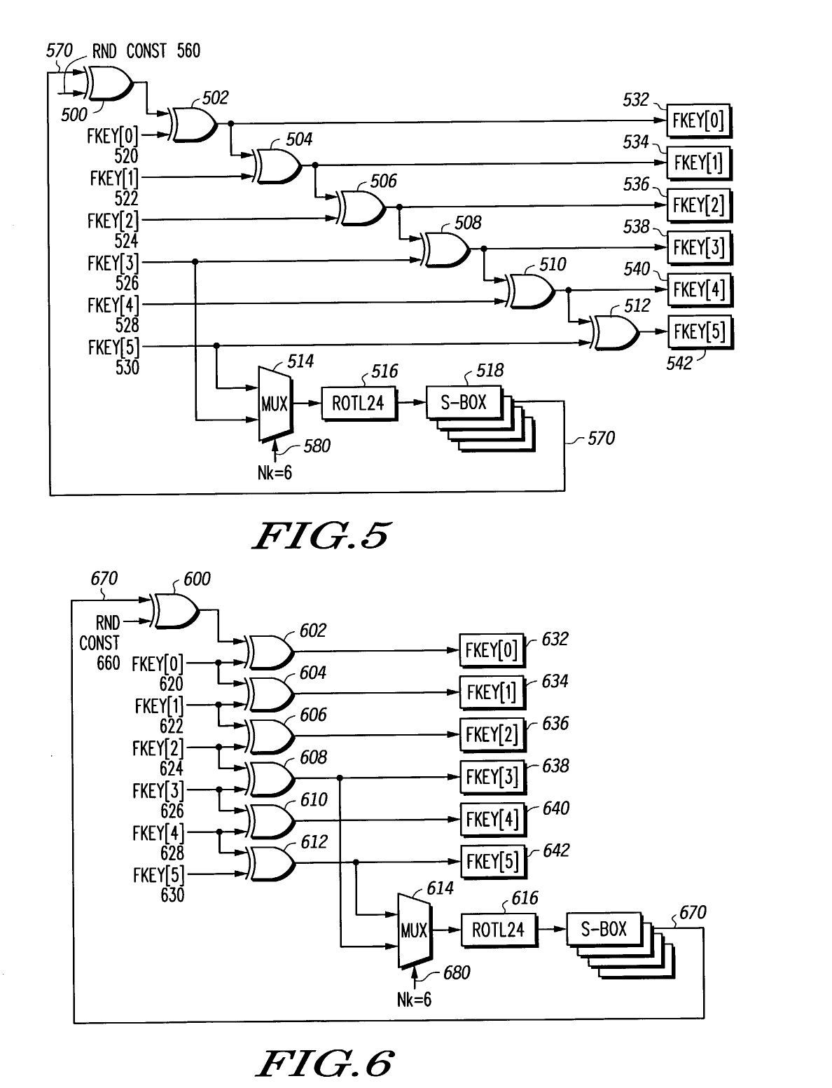

Referring now to FIG. 4, a block diagram is provided for key expansion. The key expansion includes input host key 400 where input keys are generated. These keys are received by key expansion logic/registers block 410 as well as round key decoder block 430. Key expansion logic/registers block 410 performs key expansion. Key Size 412, Round Number 414 and an input identifying whether the block is encrypting or decrypting 416 are inputs to both the key expansion logic/registers 410 and the round key decoder 430. The input identifying the round number is bounded according to the following table:

TABLE 1
Number of Rounds

| Key Size | Rounds |
|---|---|
| 128 bit (4 words) | 10 |
| 192 bit (6 words) | 12 |
| 256 bit (8 words) | 14 |

For a key size (Nk) of four or six words (128-bit or 192 bit, respectively), the forward key expansion logic is the same. In the case of Nk=4, only four round key words are generated. When Nk=6, six round key words are generated. Referring back to FIG. 2, the key expansion logic/registers 410 produces forward keys shown in block 210 and 220. For a key size (Nk) of 8 (256-bit), key expansion is similar to Nk=4/6, except that the fifth sub-key word requires an additional set of S-box lookups.

The outputs from key expansion logic/registers 410 are inputs to an inverse key function 420 and inputs to the round key decoder 430. Further, Inverse key function block 420 provides inputs to round key decoder 430. Round key decoder 430 outputs round keys 440.

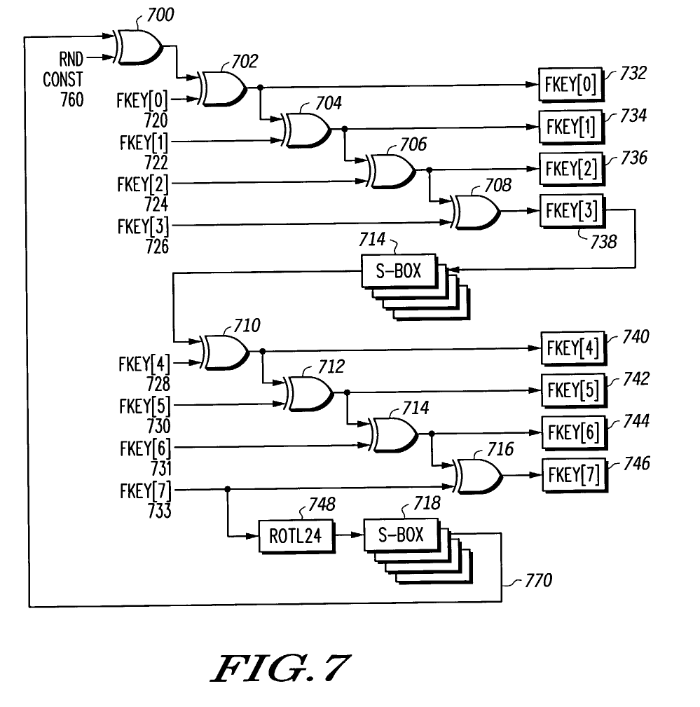

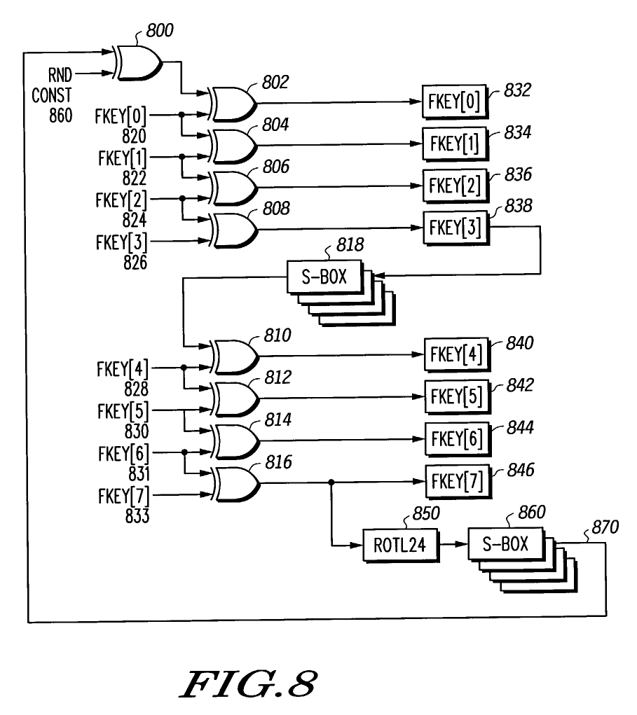

Referring to FIG. 4 in combination with FIGS. 5, 6, 7 and 8, FIGS. 5,6, 7 and 8 show the logic within key expansion logic/registers 410. More specifically, FIG. 5 shows key expansion logic gates that would be used when Nk is 4 or 6 words (128 bits or 192 bits) in length. FIG. 6 shows the reverse key expansion logic gates that would be used when Nk equals 4 or 6 words. FIG. 7 shows the key expansion logic gates used when Nk is equal to 8 words (256 bits). FIG. 8 shows the reverse key expansion logic gates used when Nk is equal to 8 words.

Referring to FIG. 5, showing logic gates for Nk equal to 4 or 6 words, the logic gates include seven XOR gates 500, 502, 504, 506, 508, 510 and 512. More particularly, XOR gate 500 receives inputs including a round constant 560 and a round key generated on the fly in S-Box 518 shown as signal 570. The logical XOR of the round constant and signal 570 produce an input to XOR 502. XOR 502 also receives a forward key 520 and produces a forward key 532, which is also an input to XOR 504. XOR 504 combines input from XOR 502 with forward key 522, producing an output that is forward key 534 and also used as an input to XOR gate 506 which combines forward key 524 to produce an output forward key 536. The output of XOR 506 provides an input to XOR 508, which combines input 526 (fkey 3) to produce a new forward key 538 (fkey 3′). The input 526 is also an input to a multiplexor (MUX) 514. The output from XOR 508 is also an input to XOR gate 510, which combines with input 528 (fkey 4) to produce 540 (fkey 4′) and an input to XOR 512. XOR 512 receives input 530 (fkey 5) and produces output 542 (fkey 5′). Input 530 (fkey 5) is also an input to multiplexor 514. Multiplexor 514 receives a control signal NK, which determines whether the register stream will use 6 words as opposed to 4 or 8 words. The output of multiplexor 514 is fed to block 516 which represents a rotational left 24 function which rotates the incoming bits left by 24 bits. The output of block 516 is received by S-Box 518 which creates the random round key for input to the system.

Although not shown for purposes of simplification of the FIG., inputs 520, 522, 524, 526, 528 and 530 are connected to the outputs of registers holding forward keys 532, 534, 536, 538, 540 and 542, respectively.

Unlike other implementations of key expansion, the output of XOR 500 is an input to XOR 502. Further, each output other than the last output from the XORs shown in FIG. 5 are used as XOR inputs. Thus, one process round is completed every cycle.

Referring to FIG. 6, a reverse key expansion implementation is shown for an Nk of 4 or 6 words. FIG. 6 shows seven XOR gates, 600, 602, 604, 606, 608, 610 and 612. XOR gate 600 receives an input round constant 660 and an input 670 received from an S-Box, XOR 600 produces an output which is fed directly to XOR 602 as an input with signal 620 (fkey 0) to produce signal 632 (fkey 0′). Input 620 (fkey 0) is also an input to XOR 604 along with signal 622 (fkey 1) to produce output 634 (fkey 1′). Signal 622 is also an input to XOR 606 which combines signal 624 (fkey 2) which produces an output 636 (fkey 2′). Input 624 is also an input to XOR 608 which combines signal 626 (fkey 3) to produce an output 638 (fkey 3′). Output 638 is also an input to multiplexor 614. Multiplexor 614 receives input 680, which determines whether the register stream will use 6 words as opposed to 4 or 8 words. The output of multiplexor 614 is fed to block 616 that represents a rotational left 24 function which rotates the incoming bits left by 24 bits. The output of block 616 is received by S-Box 618, which creates the random round key for input 670 to the system.

Although not shown for purposes of simplification of the FIG., inputs 620, 622, 624, 626, 628 and 630 are connected to the outputs 632, 634, 636, 638, 640 and 642, respectively, of registers holding forward keys.

Unlike FIG. 5, FIG. 6 uses only one output from XOR 600 as an input to another XOR. However, as shown in FIG. 5, forward round keys shown as 532, 534, 536, 538, 540 and 542 are used in the reverse key expansion as inputs 620, 622, 624, 626, 628 and 630.

More particularly, for block encryption, a key expansion engine is initialized with an input key. The input key is stored in a key expansion block and used to expand the key schedule to generate forward round keys 532 through 542. For each block decryption the key expansion engine is initialized with the last set of expanded round keys, such as forward round keys 532 through 542. The input keys are recovered by collapsing the key schedule and then the input keys are consumed in a last round of decryption, such as via forward keys 620 through 630.

Referring to FIG. 7, a key expansion architecture for a key size (Nk) of 8 words (256 bits) is shown. The key expansion for 8 words is similar to that shown in FIG. 5 for Nk=4/6, with the exception that a fifth key word requires an additional set of S-box lookups. Further, although two sets of S-boxes are shown in FIG. 7, due to the fact that only four round keys are generated per cycle, the same set of S-boxes can be used to generate all eight expanded key words. In odd rounds, the S-boxes are indexed using a value of (fkey 3). In even rounds, the S-boxes are indexed using the value of (fkey 7) rotated left by 24 bits.

More particularly, FIG. 7 shows a plurality of XOR gates 700 through 716, which function similarly to the architecture described with reference to FIG. 5. More particularly, XOR gate 700 receives inputs including a round constant 760 and a round key generated on the fly in S-Boxes 718 shown as signal 770. The logical XOR of the round constant and signal 770 produce an input to XOR 702. XOR 702 also receives a forward key 720 and produces a forward key 732, which is also an input to XOR 704. XOR 704 combines an input from XOR 702 with forward key 722, producing an output that is forward key 734 and also used as an input to XOR gate 706 which combines forward key 724 to produce an output forward key 736. The output of XOR 706 provides an input to XOR 708, which combines input 726 (fkey 3) to produce a new forward key 738 (fkey 3′).

The new forward key 738 is an input to S-Boxes 714, which produce an input to XOR gate 710, which combines with input 728 (fkey 4) to produce forward key 740 (fkey 4′) and an input to XOR 712. XOR 712 receives input 730 (fkey 5) and produces output forward key 742 (fkey 5′). The output of XOR 712 is also an input to XOR 714 along with input 731 (fkey 6). The output of XOR 714 is forward key 744 (fkey 6′) and an input to XOR 716. XOR 716 combines the output of XOR 714 and signal 733 to produce forward key 746 (fkey 7). Signal 733 is also an input to rotational block ROTL24 748 with rotates the input signal by 24 bits. The output of block 748 is an input to S-Boxes 718 which provide the signal 770 which is the random round key for input to the system at XOR 700.

Although not shown for purposes of simplification of the FIG., forward keys 720, 722, 724, 726, 728, 730, 731 and 733 are connected to the outputs of registers respectively holding forward keys 732, 734, 736, 738, 740, 742, 744 and 746.

Referring now to FIG. 8, the reverse key expansion implementation is shown for an Nk of eight words. FIG. 8 shows nine XOR gates, 800 through 816. XOR gate 800 receives an input round constant 860 and an input 870 received from S-Boxes 860. XOR 800 produces an output which is fed directly to XOR 802 as an input with signal 820 (fkey 0) to produce signal 832 (fkey 0′). Input 820 (fkey 0) is also an input to XOR 804 along with signal 822 (fkey 1) to produce output 834 (fkey 1′). Signal 822 is also an input to XOR 806 which combines signal 824 (fkey 2) which produces an output 836 (fkey 2′). Input 824 is also an input to XOR 808 which combines signal 826 (fkey 3) to produce an output 838 (fkey 3′). Output 838 is also an input to S-Boxes 818. S-Boxes 818 output is fed to XOR 810 which also receives signal 828 (fkey 4) and produces signal 840 (fkey 4′). Signal 828 is also fed to XOR 812 along with signal 830 (fkey 5) to produce signal 842 (fkey 5′). Signal 830 is also fed to XOR 814 along with signal 831 (fkey 6) to produce signal 844 (fkey 6)′). Signal 831 is also fed to XOR 816 along with signal 833 (fkey 7) to produce signal 846 (fkey 7′). Signal 846 is also provided to block 850 which represents a rotational left 24 function which rotates the incoming bits left by 24 bits. The output of block 850 is received by S-Boxes 860, which creates signal 870, the random round key for input to the system. Although not shown for purposes of simplification of the FIG., input signals 820, 822, 824, 826, 828, 830, 831 and 833 are connected to the outputs of the registers holding signals 832, 834, 836, 838, 840, 842 and 844, respectively.

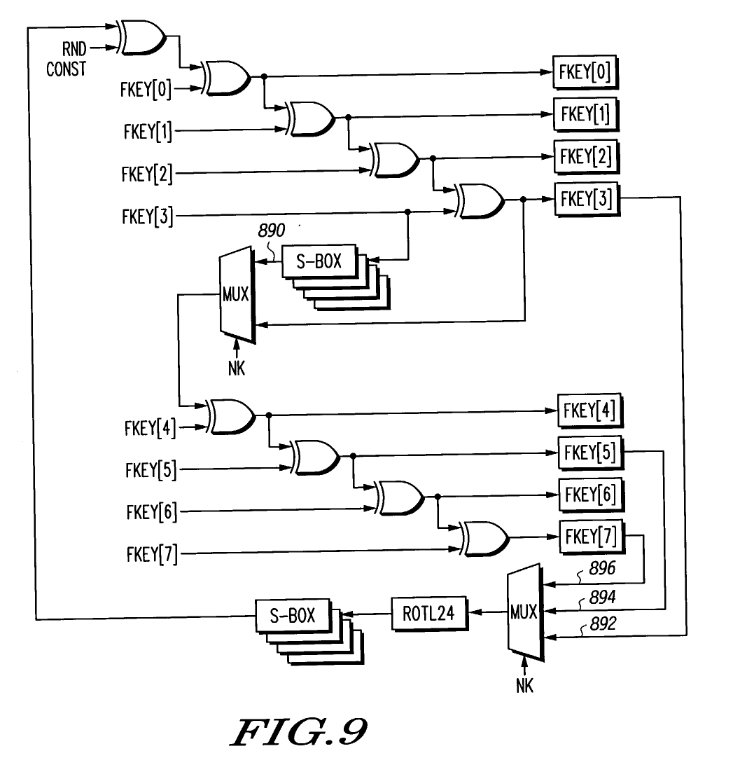

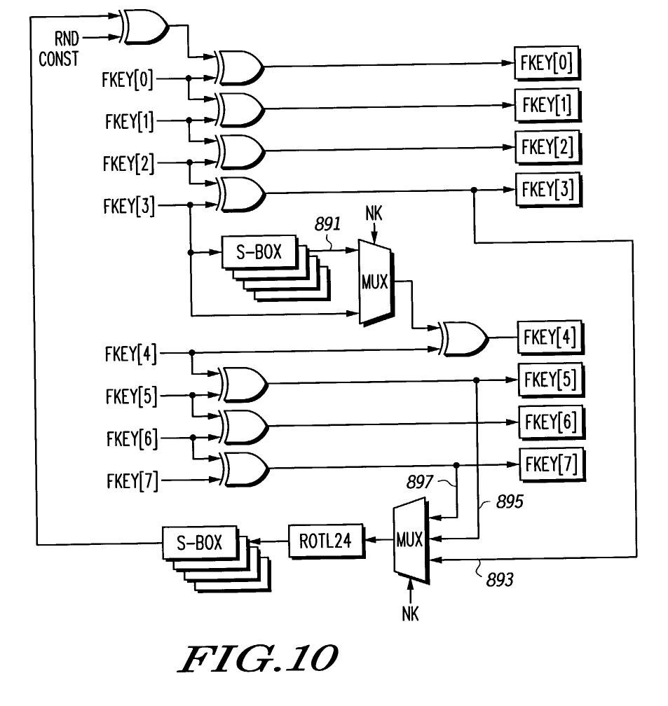

FIGS. 9 and 10 illustrates how the same logic can be shared for key sizes of 4, 6 and 8 words. More particularly, FIG. 9 illustrates an embodiment of logic sharing for forward key expansion. Lines 890 and 892 are active when a key size is 4 words in length; line 894 is active when a key size is 6 words in length; and line 896 is active when a key size is 8 words in length.

FIG. 10 illustrates an embodiment of logic sharing for reverse key expansion (collapsing) for key sizes of 4, 6 and 8 words. Lines 891 and 893 are active when a key size is 4 words in length; line 895 is active when a key size is 6 words in length; and line 897 is active when a key size is 8 words in length.

Referring now to FIG. 11, the inverse key function is shown. In an embodiment, an inverse key function on the reversed key schedule generates decryption round keys. Each expanded key word except the last Nk expanded words is multiplied by the inverse coefficient bytes “0E”, “09”, “0D”, “0B”. Each byte in a key word is multiplied by inverse coefficients via 16 parallel byte multiplies with the byte products XORed together as shown in FIG. 11.

Round key bits 31 through 24 shown as signal 930 are formed by a bit-wise XOR 902 of the four bytes formed by the bitwise multiplication of the fkeys 910, 912, 914 and 916 and the inverse coefficient bytes 920, 922, 924 and 926, respectively. Thus, fkey 910 is multiplied with inverse coefficient 920, fkey 912 is multiplied with inverse coefficient byte 922, fkey 914 is multiplied with inverse coefficient byte 924, and fkey 916 is multiplied with inverse coefficient byte 926. Round key bits 23 through 16 shown as signal 932 is formed by the bit-wise XOR 904 of a rotated version of the multiplications of the inverse coefficient bytes with the fkeys 910 through 916. More specifically, XOR 904 receives a cyclic rotation by one byte to the right.

XOR 906 produces signal 934 including round key bits 15 through 8 via another cyclic rotation by one byte to the right. XOR 908 produces signal 936 including round key bits 7 through 0 via another cyclic rotation by one byte to the right. More specifically, what is being rotated is the inverse coefficient bytes 920, 922, 924 and 926. Although not shown for purposes of simplification in each of FIG. 9 and FIG. 10, the outputs of the registers that store the forward keys [0] through [7] are connected to the inputs of the respective XOR gates.

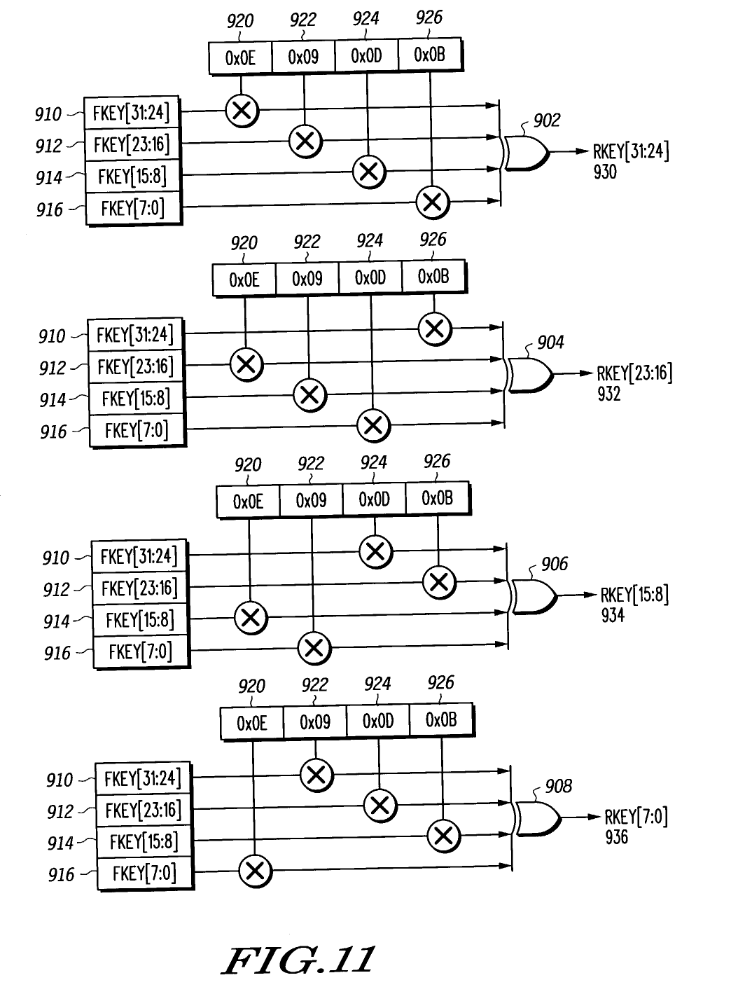

Referring now to FIG. 12, a block diagram illustrates how initial round keys are stored. Input keys 1020 are received by multiplexer 1006. Thus, the first time an input key 1020 is received by multiplexer 1006, the input key is received by initial round key block 1008 which is then transmitted by a first round block 1010 and transmitted to expand/collapse logic block 1002 wherein the key schedule is expanded and then to forward round keys block 1004 where the input key is stored. However, if select 1030 to multiplexer 1006 is in “decrypt and final keys expanded” mode, the output of forward round keys block 1004 will be passed to initial round keys block 1008 and also to expand collapse logic block 1002 as long as the select for multiplexer 1010 does not indicate that a first round 1040 is taking place.

The input key 1020 is used to initialize a key expansion engine for each block encryption. Note that the first time an input key 1020 is entered into the system, a key schedule is expanded, to generate forward round keys.

For each subsequent block decryption, the key expansion engine is initialized with a last set of expanded round keys. The words at the end of a forward key schedule are used in a first decryption round. Each subsequent decryption round consumes four words of the key schedule as it is reversed. More particularly, referring back to FIG. 2, the decryption flow shown by the right hand arrow illustrates that the original input key words are recovered as the key schedule is reversed. Storing the final set of forward expanded key words improves decryption performance. Further, the final set of forward expanded key words initializes the round process state matrix for each subsequent block decryption. Only the first block decryption requires an initial key expansion overhead. The same registers can be used to store both the final expanded round keys and the input key. Thus, part of a message can be decrypted with one key and continued after processing another message of a different context, by unloading and later reloading the final forward round keys of the original message. Thus, encryption and decryption performance is the same when processing interleaved messages with different keys.

FIG. 13 illustrates an exemplary switching between two message threads. FIG. 13 shows message A thread 1050 and message B thread 1052. The decryption of both threads by a single client is possible through context switching. As shown, in block 1054, a client establishes a connection with host A. Next, the client in block 1056 loads a first secret key (key A). The client then expands key schedule A in block 1058, decrypts part of a first message A in block 1060 and reads final words of key schedule A in block 1062. Next, a context switch occurs as shown by arrow 1064. Thereafter, client establishes a connection with host B in block 1068 and loads a second secret key (key B) in block 1070. The client then, in block 1072, expands key schedule B and decrypts message B in block 1074. In block 1076, the client reads final words of key schedule B. After reading final words of key schedule B, a context switch back to message thread A 1050 occurs as shown by arrow 1078. Thus, in block 1080, client resumes connection with host A, writes final words of key schedule A in block 1082 and decrypts the continuation portion of message A in block 1084. After decrypting the continuation portion, the client performs another context switch as shown by arrow 1086. In block 1088, the client resumes a connection with host B. In block 1090, client writes final words of key schedule B. Next, client decrypts another portion of message B as shown by the return to block 1074. The context switching can then repeat between message A and message B until both messages are completely decrypted.

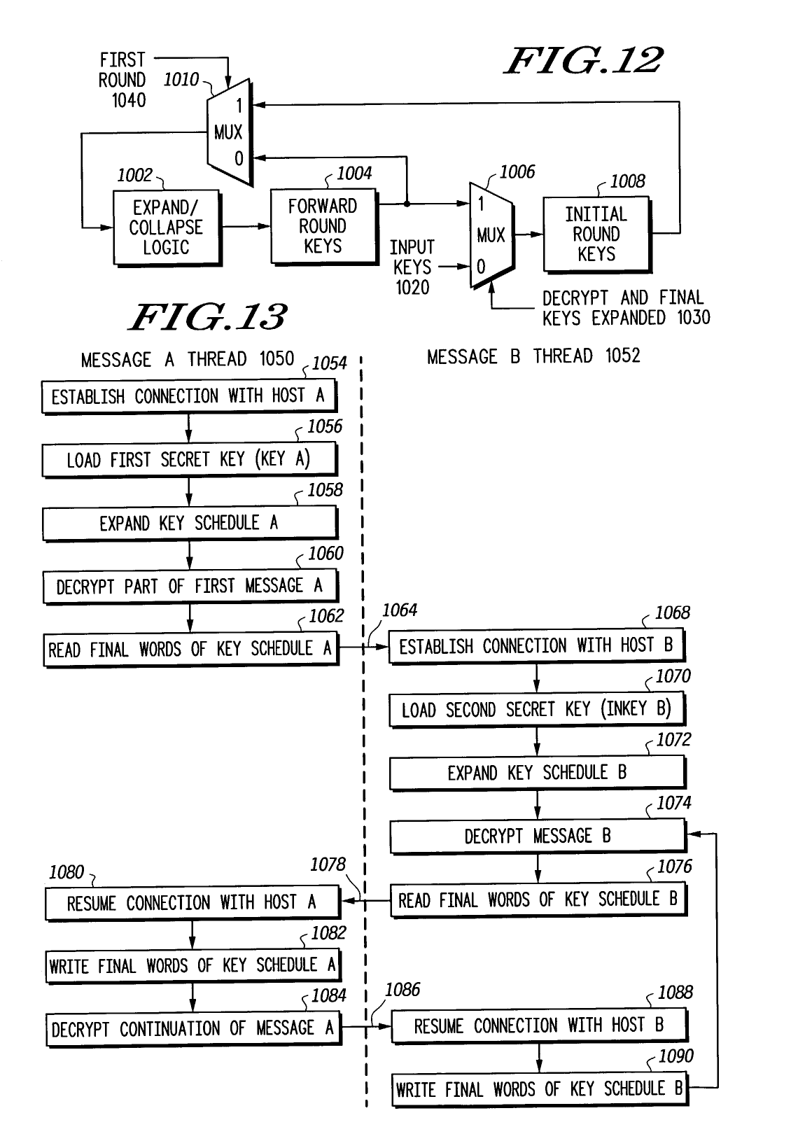

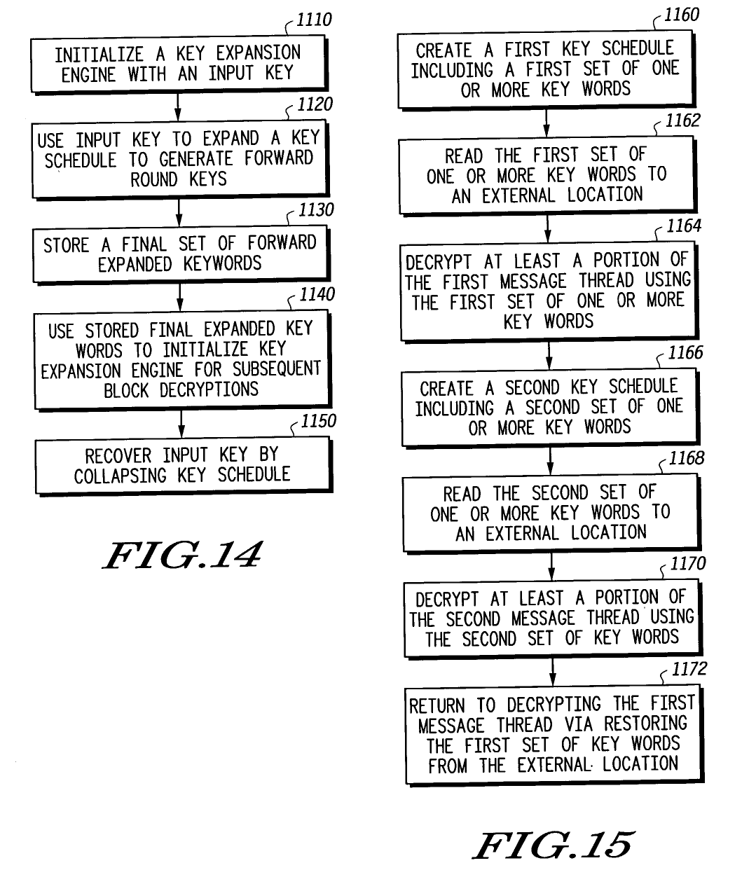

Referring now to FIG. 14, a flow diagram illustrates a method according to an embodiment shown in FIG. 10. FIG. 14 includes block 1110, which provides for initializing a key expansion engine with an input key. Block 1120 provides for using the input key to expand a key schedule to generate forward round keys. Block 1130 provides for storing a final set of forward expanded key words. Block 1140 provides for using the stored final set of forward-expanded key words to initialize the key expansion engine for each subsequent block decryption. In block 1150, the input key is recovered by collapsing the key schedule.

FIG. 15 provides another flow diagram that illustrates another method relating to decryption. Block 1160 provides for creating a first key schedule including a first set of one or more key words. Block 1162 provides for reading the first set of one or more key words to an external location. Block 1164 provides for decrypting at least a portion of the first message thread using the first set of one or more key words. Block 1166 provides for creating a second key schedule including a second set of one or more key words. Block 1168 provides for reading the second set of one or more key words to an external location. Block 1170 provides for decrypting at least a portion of the second message thread using the second set of key words. Block 1172 provides for returning to decrypting the first message thread via restoring the first set of key words from the external location.

Referring now to FIG. 16, a sub-round block is shown that includes state matrix 1202, block 1204, which selects a least significant byte, block 1206 which selects a shifted right by eight bits, block 1208 which selects a shift right by 16 bits, and block 1210 which selects a shift right by 24 bits. A 4x32 (128 bit) register file holds the working state matrix 1202. State matrix 1202 includes state addresses (addr0, addr1, addr2 and addr3), each of which are a function of a subround number and process direction, such as whether to encrypt or decrypt. The address values can be hard wired into a decoder. Table 2, below illustrates a state word address decoder appropriate for an embodiment:

TABLE 2

| | Sub- | | | | |
|---|---|---|---|---|---|
| | round | Addr0 | Addr1 | Addr2 | Addr3 |
| Encrypt | 0 | 0 | 1 | 2 | 3 |
| | 1 | 1 | 2 | 3 | 0 |
| | 2 | 2 | 3 | 0 | 1 |
| | 3 | 3 | 0 | 1 | 2 |
| Decrypt | 0 | 0 | 3 | 2 | 1 |
| | 1 | 1 | 0 | 3 | 2 |
| | 2 | 2 | 1 | 0 | 3 |
| | 3 | 3 | 2 | 1 | 0 |

The selected bits are fed to blocks 1212, which represent a mix column and inverse mix column function. The signals output by blocks 1212 are received by multiplexers 1220, 1222, 1224 and 1226. The select for multiplexers 1220, 1222, 1224 and 1226 is select 1228 which selects whether an encrypt or a decrypt function is taking place. The outputs of multiplexers 1222, 1224 and 1226 are fed to rotational blocks 1230, 1232, and 1234 which rotate the incoming signals left by 8, 16 and 24 bits respectively. Key word 1240 represents a word from the key schedule. The outputs of the rotational blocks and the output of multiplexer 1220 are fed to XOR gate 1236 to provide a state signal 1238. Signal 1240 determines whether the state is initialized by XORing via gate 1236 the input block with the first four words of the round key. A round counter begins and increments with each clock cycle. Once the round counter reaches a number of rounds specified by a controller, a done signal asserts and the contents of the state matrix 1202 are read. Each round contains four parallel subrounds. Each subround XORs one 32-bit word of the key schedule. Thus, each round consumes four words of the key schedule.

In one embodiment, each round includes four parallel 32-bit sub rounds, 0, 1, 2 and 3. A common register file is used for each four parallel 32-bit sub rounds to maximize reuse. Blocks 1212, mix column/inverse column, perform both a byte substitution and mix column when in encryption mode. Blocks 1212 perform a reverse byte substitution and inverse mix column when in decryption mode. However, for the last round, only a byte/reverse-byte substitution is performed by blocks 1212.

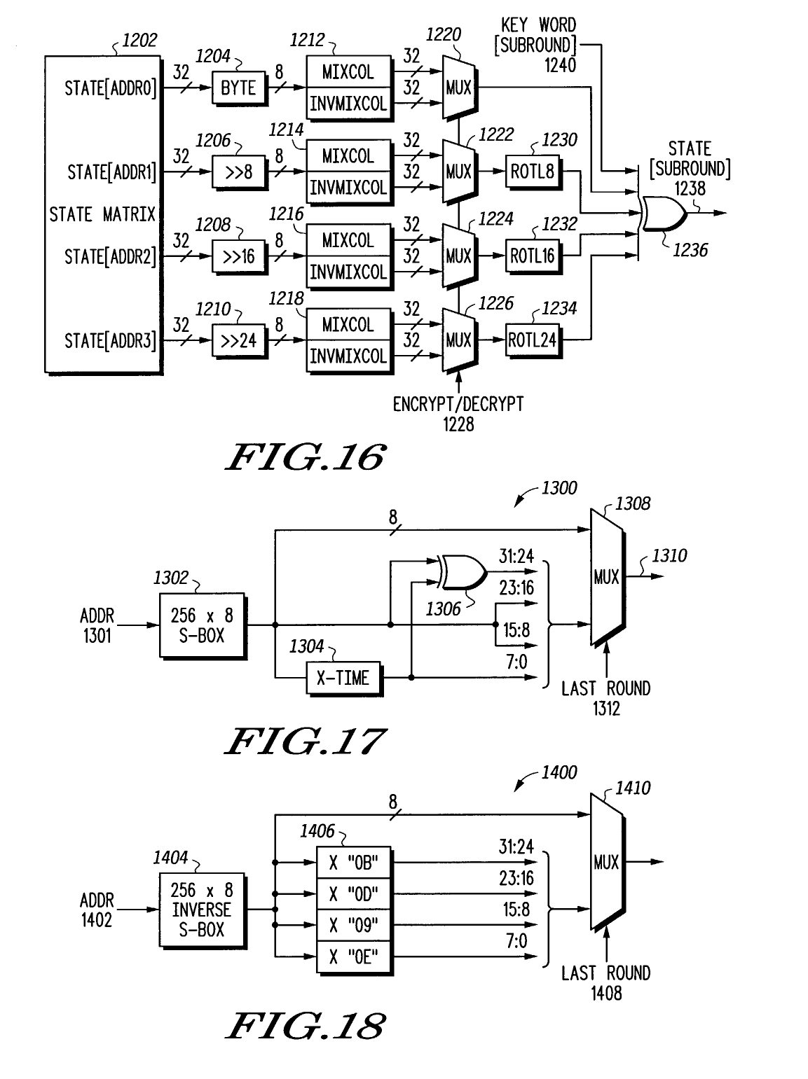

Referring to FIG. 17, an implementation of the byte substitution/mix column function is shown. The byte substitution and mix column functions are combined into a single block 1300. More particularly, the block 1300 receives an address 1301, performs an S-box byte lookup in block 1302 and multiplies the byte by a power of “x” using X-time function block 1304 for multiplication of bytes greater than 1. As shown, the output of X-time block 1304 and the output of S-box 1302 is XORed to provide bits 31 through 24, S-box 1302 provides bits 23 through 16 and bits 15 through 8, and X-time box 1304 provides bits 7 through 0. Bits 31 through 0 are then provided to multiplexer 1308 and eight bits from S-box 1302. If a last round is indicated via signal 1312, output 1310 provides only the S-box byte from block 1302, which is zero padded.

Referring now to FIG. 18, the reverse byte substitution/inverse mix column block is shown in more particularity. As shown, an address 1402 is received by inverse S-box 1404. The output of S-box 1404 is provided to block 1406 which performs multiplications and to multiplexer 1410. Multiplexer 1410 receives the multiplied bytes and eight non-multiplied bits and select 1408 determines the output depending on whether a last round occurs.

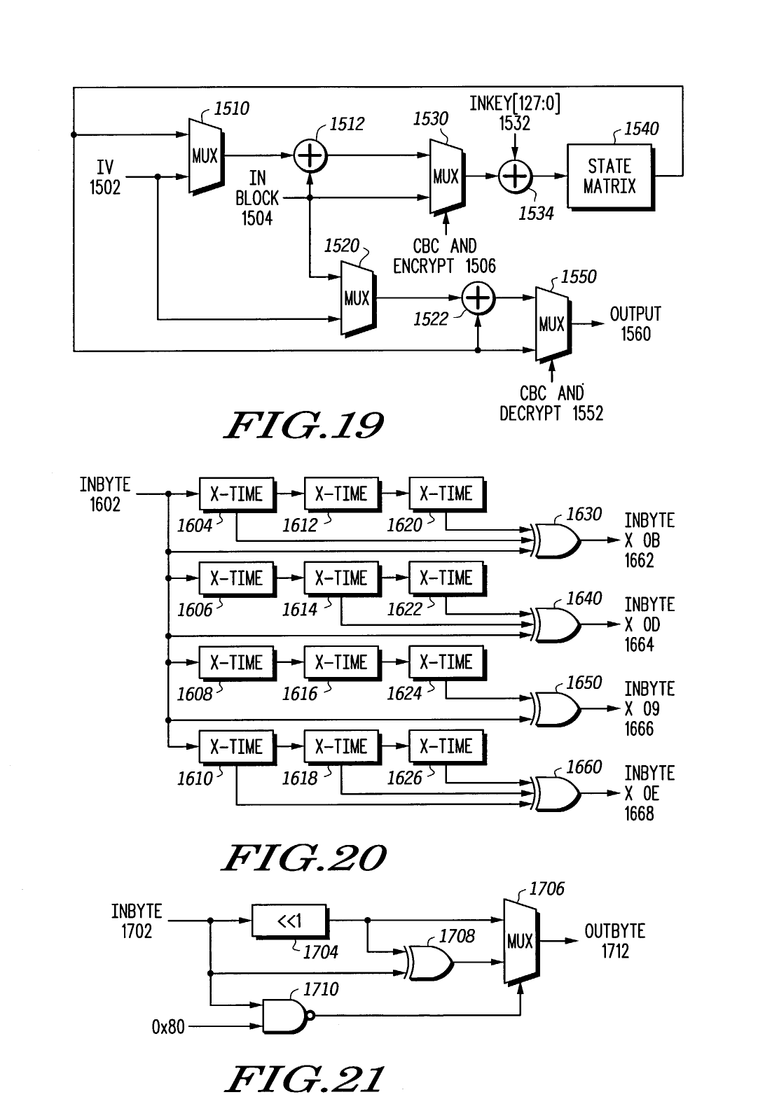

Referring now to FIG. 19, a cipher block chaining implementation is shown. More specifically, cipher block chaining (CBC) can be used or an electronic code book (ECB) can be used. For an ECB mode, each input block is processed independently. In CBC mode, a previous block is used to process a next block. CBC mode requires a 128-bit initialization vector shown as signal 1502. As shown, signal 1502 is received by decoder 1510 and a input from state matrix 1540 and each are combined with combiner 1512, which is a 128-bit XOR function, and provided to multiplexer 1530. Multiplexer 1530 also receives input block 1504. Select 1506 determines whether a CBC mode and encryption is chosen. The output of multiplexer 1530 is provided to combiner 1534 which also receives input key bits 0 through 127 1532. The output of combiner 1534 is provided to state matrix 1540. The 128-bit initialization vector 1502 is also provided to decoder 1520 with input block 1504 to provide a signal to combiner 1522, which combines the state matrix signal from state matrix 1540 and provides a signal to multiplexer 1550. Multiplexer 1550 also receives a non-combined state matrix signal. The select for multiplexer 1550, chooses whether a CBC and decrypt mode 1552 will take place, and provides an output 1560 when in decryption mode.

Referring now to FIG. 20, a block diagram illustrates byte multiplication with inverse coefficients. As shown, input bytes 1602 are received by X-time blocks 1604, 1606, 1608 and 1610, and each respective signal is fed to X-time blocks 1612, 1614, 1616 and 1618 and then to X-time blocks 1620, 1622, 1624 and 1626. XOR gate 1630 receives the output of X-time block 1604 and 1620 and input byte 1602. XOR gate 1640 receives the output of X-time block 1614 and 1622 and input byte 1602. XOR gate 1650 receives the outputs of X-time block 1624 and input byte 1602. XOR 1660 receives the outputs of X-time blocks 1610, 1618 and 1626. The outputs of XORS 1630, 1640, 1650 and 1660 provide the input byte multiplied by hexidecimal numbers 0B, 0D, 09 and 0E, respectively.

Referring now to FIG. 21, an implementation of the X-time function is shown. Input byte 1702 is input to block 1704, which performs a left shift by 1 bit function to XOR gate 1708 and to inverted AND gate 1710 which also receives number 0x80. The output of inverted AND 1710 is provided as a select to multiplexer 1706. Multiplexer 1706 also receives the outputs of block 1704 and XOR 1708 to provide the output byte 1712.

Each process round requires one clock cycle. The number of rounds depends on the key size. Encryption requires no key expansion overhead because round keys are generated on the fly. During decryption a key schedule is fully expanded prior to block processing, therefore decryption requires key expansion overhead.

The number of cycles required to encrypt or decrypt process a signal block for each key size (128, 192 and 256 bit) is provided in Table 3, below.

| | 128 bit key | 192 bit key | 256 bit key |
|---|---|---|---|
| Encrypt | 11 | 13 | 15 |
| Decrypt | 21 | 25 | 29 |

After the initial key expansion is completed for a first block, all subsequent block decryptions take a same number of cycles as encryption as shown in Table 4:

| | 128 bit key | 192 bit key | 256 bit key |
|---|---|---|---|
| Encrypt | 11 | 13 | 15 |
| Decrypt | 11 | 13 | 15 |

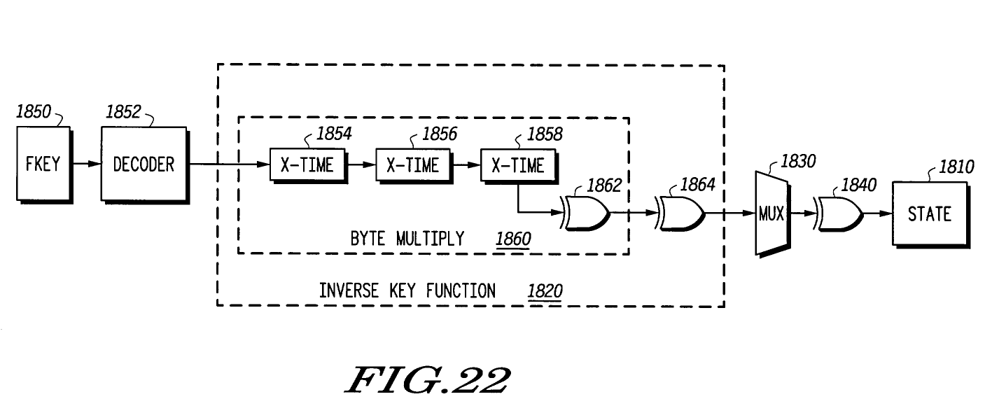

Referring now to FIG. 22, a critical path block diagram is shown that shows that the longest logic path runs from a key expansion block into a round process block working state matrix 1810 when in decryption mode. As shown, in decryption mode, the reverse expanded key words 1850 must first enter decoder 1852, through an inverse key function 1820 and a round key output decoder 1830 before being added with XOR gate 1840 to state matrix 1810. Inverse key function 1820 includes byte multiply block 1860, which includes X-time block 1854, X-time block 1856, X-time block 1858, and XOR gate 1862; and XOR 1864.

A final set of forward-expanded key words from a first decrypted block is stored and used to initialize round keys in subsequent block decryptions. Thus, there are equivalent encrypt and decrypt throughout for multiple block processing. Further, only the first block decryption requires an initial key expansion overhead. In one or more embodiments, the same registers can be used to store expanded round keys and the input key.

According to an embodiment, part of a message can be decrypted with one key and continued after processing another message of a different context, by unloading and later re-loading the final forward round keys of the original message. Thus, encryption and decryption performance is the same when processing interleaved messages with different keys.

Regarding the signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

Other Embodiments

Although particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Those skilled in the art will also appreciate that embodiments disclosed herein may be implemented as software program instructions capable of being distributed as one or more program products, in a variety of forms including computer program products, and that the present invention applies equally regardless of the particular type of program storage media or signal bearing media used to actually carry out the distribution. Examples of program storage media and signal bearing media include recordable type media such as floppy disks, CD-ROM, and magnetic tape transmission type media such as digital and analog communications links, as well as other media storage and distribution systems.

Additionally, the foregoing detailed description has set forth various embodiments of the present invention via the use of block diagrams, flowcharts, and/or examples. It will be understood by those skilled within the art that each block diagram component, flowchart step, and operations and/or components illustrated by the use of examples can be implemented, individually and/or collectively, by a wide range of hardware, software, firmware, or any combination thereof. The present invention may be implemented as those skilled in the art will recognize, in whole or in part, in standard Integrated Circuits, Application Specific Integrated Circuits (ASICs), as a computer program running on a general-purpose machine having appropriate hardware, such as one or more computers, as firmware, or as virtually any combination thereof and that designing the circuitry and/or writing the code for the software or firmware would be well within the skill of one of ordinary skill in the art, in view of this disclosure.

What is claimed is:

1. A method of performing an encryption and a decryption, the method comprising:
selecting a block cipher algorithm to be implemented;
generating encryption and decryption round keys for the selected block cipher algorithm using an accelerator module; and
implementing the accelerator module using shared logic for one or more round key sizes, wherein the decryption uses a stored expanded key word to initialize subsequent block decryptions and the use of the stored expanded key word to initialize subsequent block decryptions equalizes encryption and decryption performance when processing interleaved messages with different keys.

2. The method of claim 1 wherein the block cipher algorithm is a Rijndael algorithm.

3. The method of claim 1 wherein only a first block decryption requires expansion overhead.

4. The method of claim 3 wherein subsequent block decryptions utilize a prior key to initialize a state matrix for a plurality of subsequent blocks.

5. The method of claim 4 wherein the subsequent block decryptions are performed at a same rate as block encryptions.

6. The method of claim 1 wherein the accelerator module has a reduced area due to the sharing of logic.

7. The method of claim 1 wherein a final set of forward expanded key words is unloaded as message content.

8. The method of claim 1 wherein a final set of forward expanded key words is loaded as message content.

9. A method for decrypting at least a first message thread and a second message thread, the method comprising:
using a first key schedule to expand a first input key to generate a first set of one or more forward round keys;
decrypting at least a portion of the first message thread using the first set of one or more of the forward round keys;
storing the first set of one or more of the forward round keys to an external location;
using a second key schedule to expand a second input key to generate a second set of one or more forward round keys;
decrypting at least a portion of the second message thread using the second set of one or more of the forward round keys;
storing the second set of one or more of the forward round keys to the external location; and
returning to decrypting the first message thread via restoring the first set of one or more of the forward round keys from the external location, thereby performing subsequent block decryptions at a same rate as block encryptions.

10. The method of claim 9 wherein the first set and the second set consist of an end portion of a first and second key schedule.

11. The method of claim 9 wherein the first key schedule and the second key schedule are independent of each other.

12. The method of claim 9 wherein the returning to decrypting is independent of recreating the first key schedule.

13. The method of claim 9 wherein decrypting is performed via a plurality of logic gates configured to reuse expanded key words from a prior decryption round, if any.

14. An apparatus configured for encryption and decryption, the apparatus comprising:
a plurality of logic gates configured to reuse expanded round keys from a prior decryption block, wherein the logic gates complete one round of data decryption per clock cycle after an initial round of data decryption;
a plurality of decoders configured to convert the decrypted data to usable data; and
storage means coupled to the decoders for storing expanded round keys associated with a first round of data decryption and using the expanded round keys in one or more later decryption blocks.

15. The apparatus of claim 14 wherein the plurality of decoders are S-boxes that calculate byte multiplications for each value.

16. The apparatus of claim 14 wherein the plurality of decoders is a plurality of 256×8 decoders.

17. An apparatus for cryptographically processing data, the apparatus comprising:
means for generating encryption and decryption round keys for an accelerator module; and
means for implementing the accelerator module using shared logic for one or more round key sizes, wherein decryption implemented by the accelerator module uses one or more stored final forward round keys to initialize subsequent block decryptions to make subsequent block decryptions occur at a same rate as block encryptions.
